(19) United States
(12) Patent Application Publication
(10) Pub. No.: US 2005/0268845 A1
(43) Pub. Date: Dec. 8, 2005

(54) Apparatus and nozzle plate for dispensing liquid material

(75) Inventors: Charles P. Ganzer, Cumming, GA (US); Christopher R. Chastine, Hoschton, GA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation, Westlake, OH (US)

(21) Appl. No.: 10/860,300

(22) Filed: Jun. 3, 2004

(51) Int. Cl. B05C 5/00

(52) U.S. Cl. 118/300

(57) ABSTRACT

A nozzle for a liquid dispenser of liquid materials, such as thermoplastic adhesives, including a plurality of liquid passageways coupled in fluid communication with a supply passage of the dispenser. The nozzle includes one or more liquid passageways coupled in fluid communication with the supply passage. Each liquid passageway has an outlet on a downstream surface of the nozzle. A surface finish proximate to each outlet having a surface roughness of less than or equal to about 16 microinches. The intersection defined at the outlet between a sidewall of the corresponding liquid passageway and the downstream surface is geometrically sharp. The nozzle may have the form of a flat plate.

### FIELD OF THE INVENTION

The invention generally relates to liquid dispensing and, more particularly, to liquid dispensers for dispensing heated liquids onto a surface of a substrate.

### BACKGROUND OF THE INVENTION

In many liquid-dispensing applications, patterns of liquid material, such as an adhesive or thermoplastic material, are applied to a moving or stationary substrate. A familiar type of liquid dispenser includes a multi-orifice dispensing nozzle assembly featuring a plurality of nozzles each having a tip that projects from an adapter support plate or block. The individual nozzle tips are separate components that are brazed, pressed, threaded or otherwise fastened to the adaptor support block with an arrangement suitable to create a dispensed pattern of liquid material on the substrate. Metered amounts of liquid material are discharged from the orifice of each nozzles as individual streams cyclically interrupted by opening and closing one or more upstream supply valves. The permissible degree of projection of the nozzle tip from the support block is a function of the tip's outer taper geometry and the application-specific need to prevent bridging of the spaces between adjacent nozzle tips. Bridging results in material accumulation in these spaces, which acts to periodically degrade pattern quality when the accumulated material is liberated from the nozzle assembly during a dispensing event. In applications that cannot tolerate degradation of pattern quality even for a brief duration, bridging must be eliminated or, at the least, must be minimized. Conventional nozzles cannot satisfy this requirement.

Conventional nozzles used for dispensing thermoplastic materials incorporate one or more dispense channels each having an outlet on a downstream surface that is chamfered or radiused. As a result, the sidewall of the dispense channel and the downstream surface are united by a chamfered or radiused surface and are not coextensive. The final machining step concluding the manufacture of conventional nozzles is to remove internal burrs extending from the sidewall into the dispense channel with a chamfer tool. This de-burring procedure produces the chamfer or radius of the outlet. The outlet may also be broken by discontinuities such as pits or inclusions. Any of these defects, such as burrs, a chamfer or radius, or pits and inclusions, may degrade dispensing pattern quality by causing material accumulation and/or bridging.

It would be desirable to improve the quality and reproducibility of patterns of liquid material dispensed from multi-orifice liquid dispensers by reducing or eliminating material accumulation and bridging.

### SUMMARY

The invention provides nozzles and dispensers for dispensing patterns of liquid material with improved quality and reproducibility. In accordance with one embodiment of the invention, a dispenser includes a liquid supply passage and a valve operative for directing substantially uniform output volumes of the liquid material into the liquid supply passage. A nozzle mounted to the dispenser includes a downstream surface, a plurality of liquid passageways each including an outlet on the downstream surface, and a supply cavity coupling the liquid passageways in fluid communication with the liquid supply passage. The surface finish of the downstream surface has a surface roughness of less than or equal to about 16 microinches. In addition, an intersection between the sidewall of each of the liquid passageways and the downstream surface is geometrically sharp. In certain alternative embodiments, the supply cavity may have a volume substantially equal to each of the output volumes of the liquid material supplied from the liquid supply cavity. In other embodiments, the nozzle includes a single liquid passageway and associated outlet on the downstream surface and lacks a supply cavity.

The nozzle plate and dispensers of the invention minimize or eliminate liquid material build-up by presenting a smooth surface that resists material accumulation and bridging. The outlets of the dispense passage in the nozzle plate may be arranged in a wide variety of patterns without the design limitations imposed by protruding nozzle tips, in which the spacing between adjacent beads or drops of liquid material is limited by nozzle size.

Heat transfer is improved to the liquid material residing in the liquid passageways of the nozzle plate. Eliminating protruding nozzle tips more uniformly distributes heat throughout the nozzle plate so that the temperature of the nozzle plate is more homogeneous. Specifically, the absence of nozzle tips eliminates projections that are susceptible to heat loss.

These and other objects and advantages of the present invention shall become more apparent from the accompanying drawings and description thereof.

### BRIEF DESCRIPTION OF THE FIGURES

The accompanying drawings, which are incorporated in and constitute a part of this specification, illustrate embodiments of the invention and, together with a general description of the invention given above, and the detailed description given below, serve to explain the principles of the invention.

FIG. 1 is a side view of a liquid dispenser having a nozzle constructed in accordance with one embodiment of the invention;

FIG. 2 is a perspective view of the nozzle plate of FIG. 1 viewed from an upstream location;

FIG. 3 is an enlarged cross-sectional view of the liquid adhesive dispenser of FIG. 1 taken generally along line 3-3 in FIG. 2;

FIG. 4 is an enlarged view of a portion of FIG. 3;

FIG. 5 is a bottom view of the nozzle plate of FIG. 2 viewed from a downstream location;

FIG. 6 is a diagrammatic view of a pattern of liquid material dispensed on a substrate by the nozzle plate of FIG. 2;

FIG. 7 is another side view of the liquid dispenser similar to FIG. 1;

FIGS. 8-11 are perspective views similar to FIG. 2 of nozzles in accordance with alternative embodiments of the invention; and

FIG. 12 is a side view of another nozzle constructed in accordance with an embodiment of the invention.

### DETAILED DESCRIPTION OF THE PREFERRED EMBODIMENTS

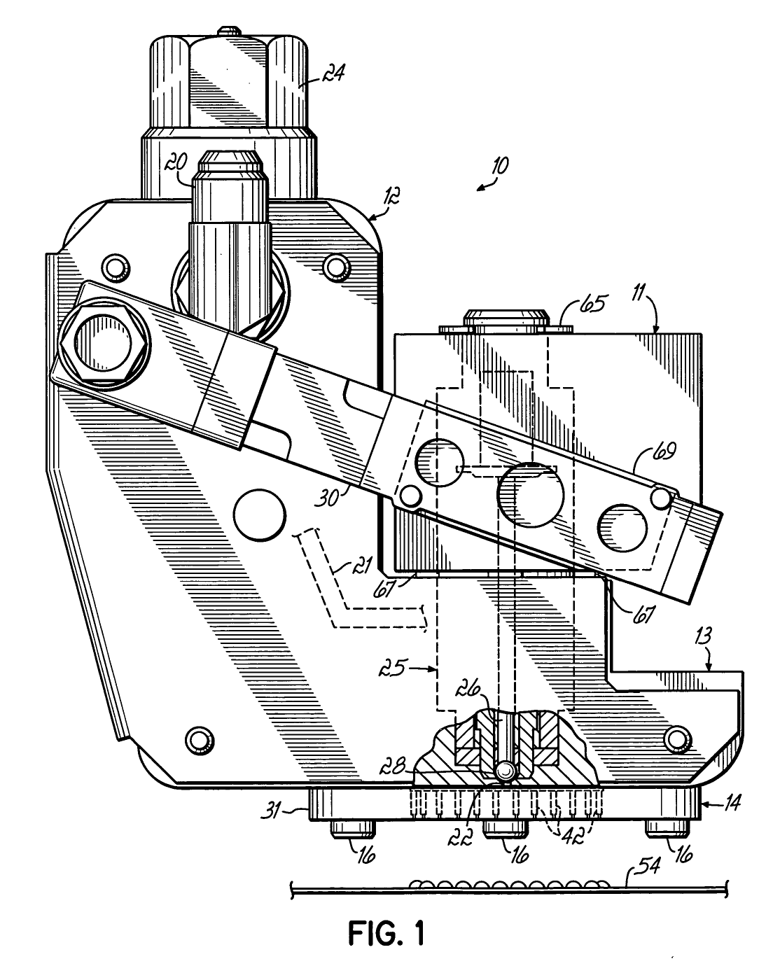

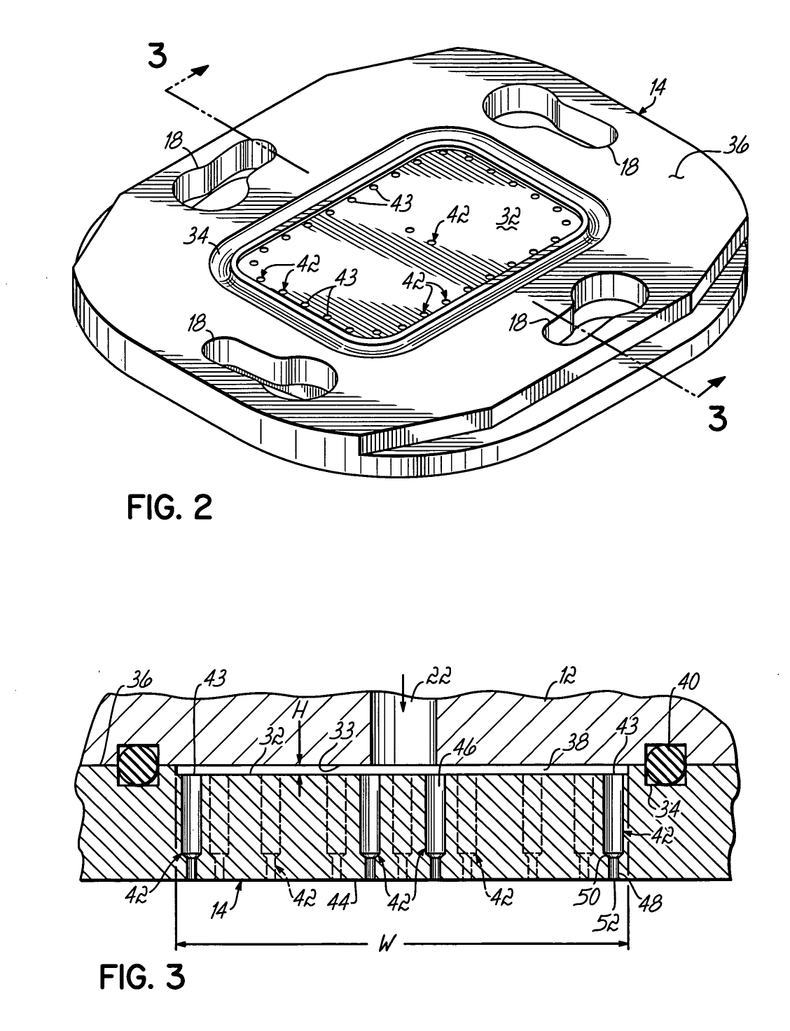

With reference to FIGS. 1 and 2, a gun or dispenser 10 includes an air manifold 11, a liquid manifold 12, a dispensing head 13, and a nozzle or nozzle plate 14 secured to dispensing head 13 by a plurality of, for example, four conventional fasteners 16 received in a corresponding plurality of keyhole-shaped slots 18 extending through the nozzle plate 14. A hydraulic fitting 20 is adapted to be coupled with a hydraulic hose (not shown) through which liquid material, such as hot melt adhesive, is supplied to the dispenser 10. Liquid material is conveyed from the hydraulic fitting 20 to the nozzle plate 14 through a liquid passage 22 extending through the liquid manifold 12. A filter cartridge 24 includes a filter element (not shown) disposed in the liquid path upstream of the liquid passageway removes any foreign matter present in the liquid material.

To mount the nozzle plate 14 to the dispensing head 13, the heads of fasteners 16 are initially registered with the corresponding large diameter openings of slots 18 and the heads of fasteners 16 are withdrawn from the threaded openings in dispensing head 13 to provide clearance between the nozzle plate 14 and each fastener 16. The nozzle plate 14 is then rotated clockwise, as viewed in FIG. 2, to engage the shank of each fastener 16 with the corresponding narrow-width portion of the corresponding one of the slots 18. The nozzle plate 14 is thereby secured between the heads of fasteners 16 and the confronting surface 33 of the dispensing head 13, as best shown in FIG. 3.

A module or valve 25 of dispenser 10 includes a valve element 26 to selectively supply liquid material to liquid supply passage 22 in an cyclic fashion by periodically engaging a valve seat 28 disposed in liquid supply passage 22. Valve 25 may be a standalone module or a cartridge, such as the valve shown in U.S. Pat. No. 5,934,520. The invention contemplates that the valve 25 may be operated pneumatically or electrically, or through other mechanisms, the details of which are not necessary for a full understanding of the invention, and that many other alternative dispenser configurations may be used as well. In the representative dispenser 10, a solenoid valve 30 switches actuation air pressure to the valve 25 for operating an air piston (not shown) that moves valve element 26. Valve 25 may be, for example, a Series H-440 module commercially available from Nordson Corporation of Westlake, Ohio, which is the assignee of the invention.

With reference to FIGS. 1-5, a central upstream surface 32 of nozzle plate 14 is circumscribed by a groove 34 and is recessed below a surrounding peripheral surface 36. A supply cavity 38 (FIG. 3) is defined by surface 32 as a bounded volume situated between the nozzle plate 14 and the confronting surface 33 of the dispensing head 13 when the nozzle plate 14 is fastened to the dispensing head 13. The flat, thin and generally rectangular supply cavity 38 has a vertical dimension adequate to obtain the proper uniformity, which is likely viscosity dependent. The liquid pressure is approximately uniform throughout the volume of the supply cavity 38, which aids in uniform dispensed amounts of liquid material from each passageway 42.

The volume of the supply cavity 38 is substantially equal to the desired output volume of liquid material being dispensed by a single cycle of valve 25. Preferably, the two volumes are equal to within ±15 percent. The substantial equivalency between the volume of supply cavity 38 and the desired output volume of liquid material has been observed to optimize dispense pattern quality. If the volume in the supply cavity 38 were significantly greater than the desired output volume, it is believed that pattern quality would be degraded by increased stringing after the dispensing event because of the additional dispense volume occurring during the resulting extension of the depressurization phase following valve closure. If the volume of supply cavity 38 were significantly less than the desired output volume, a fluid flow restriction would result within the supply cavity 38 thus degrading pattern quality due to reduced exit velocity at the outlets 52 as well as a reduced dispense volume. To optimize pattern quality, it is believed that operating valve 25 with the shortest possible valve on time and highest possible hydraulic pressure is beneficial in terms of maximizing exit velocity at the outlets 52 and reducing system supply pressure losses following a given dispense event.

With continued reference to FIGS. 1-5, a sealing member 40, such as an O-ring, positioned in the groove 34 seals the periphery of supply cavity 38. Compression of the sealing member 40 between the dispensing head 13 and the nozzle plate 14 prevents leakage of liquid material between the fastening surface 36 and the contacting surface of the dispensing head 13. The liquid supply passage 22 communicates with the supply cavity 38 for supplying liquid material to the supply cavity 38.

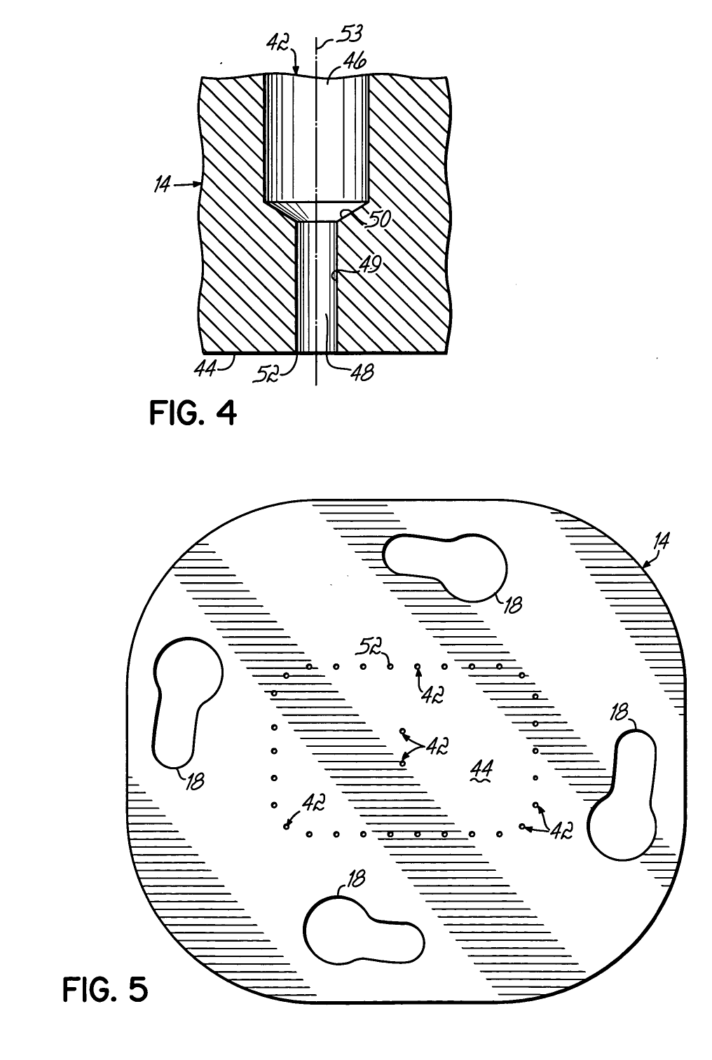

A plurality of spaced-apart liquid passageways 42 extend through the nozzle plate 14 from the upstream surface 32 to a generally planar downstream surface 44. In certain embodiments of the invention, the liquid supply passage 22 is positioned to intersect the supply cavity 38 at or near the geometrical center of supply cavity 38 for balanced fluid distribution to the channels 42. Each passageway 42 has a pre-dispense passageway 46 coupled by a frustoconical linking channel 50 with a dispense passageway 48, as best shown in FIG. 4. The dispense passageway 48 is smaller diametrically than the pre-dispense passageway 46 and, therefore, the linking channel 50 tapers from its upstream junction with the pre-dispense passageway 46 to its downstream junction with the dispense passageway 48. The larger diameter of the pre-dispense passageway 46, as compared with the dispense passageway 48, is believed to assist in establishing laminar flow of the liquid material in the passageway 42 before the liquid material enters the dispense passageway 48. In specific embodiments of the invention, the dispense passageway 48 has a diameter in the range of about 0.008 inches to about 0.028 inches and the pre-dispense passageway 46 has a diameter of about 0.040 inches independent of the diameter of dispense passageway 48.

With reference to FIGS. 3-5, the pre-dispense passageway 46 of each passageway 42 includes an inlet port 43 defined on the upstream surface 32 that communicates with the supply cavity 38 for receiving liquid material therefrom. The dispense passageway 48 of each passageway 42 includes an outlet 52 located on the downstream surface 44. A centerline 53 of each dispense passageway 48 is substantially perpendicular to the downstream surface 44, so that the outlets 52 are substantially circular. Each outlet 52 may be angled slightly relative to the downstream surface 44 so that the outlets 52 are oval or elliptical.

When the valve element 26 is disengaged from valve seat 28 (FIG. 1), the temporary pressure increase from liquid material entering the supply cavity 38 causes liquid material to flow from the supply cavity 38 through the channels 42 and to be dispensed from outlets 52. The flow of liquid within the supply cavity 38 to the channels 42 is balanced so that the amount of liquid material dispensed from each outlet 52 is substantially uniform among the various different channels 42.

With continued reference to FIGS. 3-5, a sidewall 49 of the dispense passageway 48 intersects the downstream surface 44 so that each outlet 52 is substantially flush with the downstream surface 44. Sidewall 49 may intersect downstream surface 44 so that, at every point about the circumference of outlet 52, the intersection is at approximately a right angle. The resultant outlet 52 is circular or approximately circular.

In certain alternative embodiments, the centerline 53 of one or more dispense passageways 48 may be inclined relative to the downstream surface 44 so that each corresponding outlet 52 is non-circular (i.e. oval). Under these circumstances, the angle at which the sidewall 49 intersects the downstream surface 44 will depend upon the location on the circumference of the outlet 52. However, for any diameter of the outlet 52, the sum of the intersection angles between the sidewall 49 and the downstream surface 44 at diametrically opposed points on the circumference of outlet 52 will equal 180°.

The flushness if provided, at least in part, by applying a smooth surface finish to downstream surface 44, which operates to better define the edge or corner defined by outlet 52 about its circumference. The surface finish may vary but, in certain embodiments, is characterized numerically by an Ra of less than about 16 microinches (0.8 μm). The surface finish is provided by grinding and lapping operations familiar to persons of ordinary skill in the art. The outlet 52 is not chamfered or otherwise radiused. The invention contemplates that only the portions of the downstream surface 44 locally surrounding the outlets 52 may have the prescribed smooth surface finish, as opposed to the entire downstream surface 44. The intersection of each dispense passageway 48 and the downstream surface 44 produces a smooth, continuous and unbroken edge of the corresponding outlet 52 so that no appreciable features are present to interact with the liquid material dispensed from the outlet 52, which improves the character of the streams of dispensed liquid material.

The closed edge or corner defined at each outlet 52 by the intersection of corresponding the sidewall 49 with downstream surface 44 is geometrically sharp, continuous and unbroken. Accordingly, the edge defined by each outlet 52 is free of visible defects, such as chamfer, radius, scratches, or burrs, when viewed at a magnification of sixty-three (63) power or less. The transition between the sidewall 49 and the downstream surface 44 is angularly abrupt and the sidewall 49 and the downstream surface 44 are not interconnected or otherwise joined by a chamfered or radiused edge. The direct intersection between the sidewall 49 and the downstream surface 44 results in a coextensive, geometrically sharp edge about the entire circumference of outlet 52.

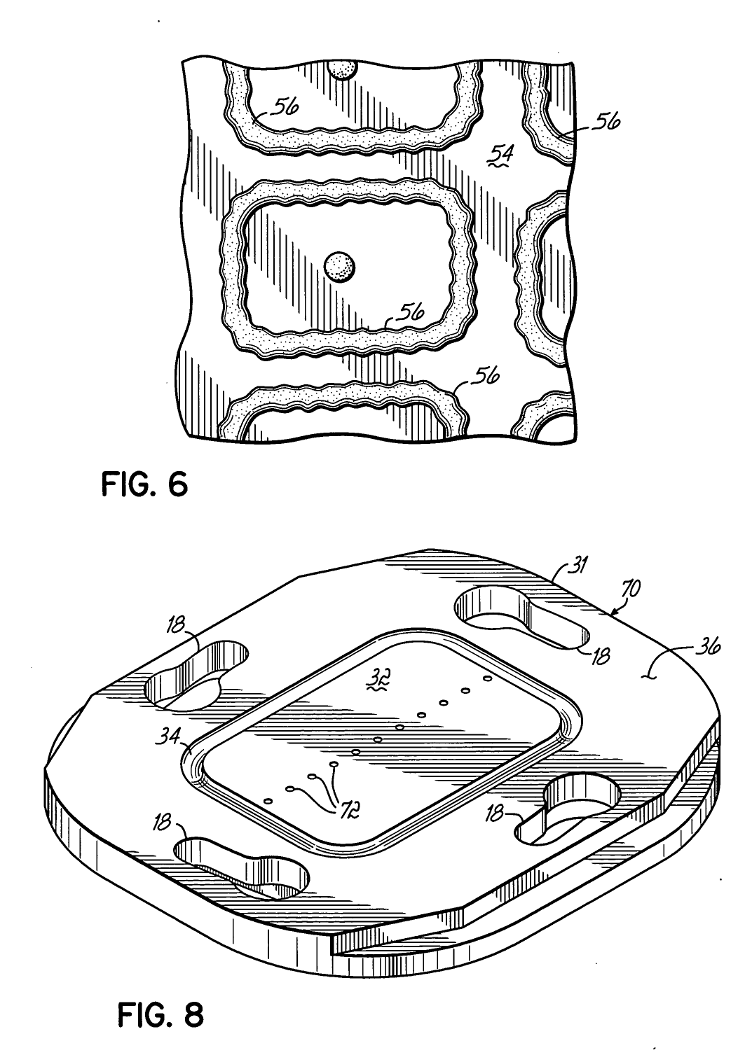

The arrangement of outlets 52 and the centerline spacing between adjacent outlets 52 determines the pattern of liquid material dispensed onto the substrate 54 (FIG. 6). The dispense passageways 48 and, therefore, outlets 52 may be arranged in any suitable configuration to dispense a selected pattern of liquid material on the substrate 54. With reference to FIG. 6, the resultant dispense pattern dispensed by this arrangement of dispense passageways 48 produces a pattern of liquid material, generally indicated by reference number 56, that includes of a rectangular bead of liquid material and a central bead of liquid material encircled by the rectangular bead.

The nozzle plate 14 is readily interchangeable with a different nozzle plate 14 having a different arrangement for passageways 42 so long as each passageway 42 communicates at one open end with the supply cavity 38. The arrangement of passageways 42 is otherwise arbitrary and the exchange is accomplished by merely mounting the replacement nozzle plate 14 to the dispenser 10 and without otherwise modifying the dispenser 10. This affords considerable flexibility in selecting and changing the dispensed pattern of liquid material.

In use and with reference to FIGS. 1-6, valve element 26 of valve 25 is moved relative to valve seat 28 in a cyclic on/off fashion disposed to supply successive output volumes of liquid material through liquid supply passage 22 to supply cavity 38. Each of the output volumes is approximately equal to the volume of the supply cavity 38. When the supply cavity 38 is pressurized by supplied output volume, liquid material flows into the inlet port 43 of each passageway 42, travels the length of each passageway 42, and is dispensed simultaneously from each outlet 52 as an individual stream that wets a substrate 54 (FIG. 1). Each output volume is distributed substantially equally among the liquid passageways 42.

Adjacent amounts of liquid material deposited by the individual streams may flow on the substrate 54 and merge or coalesce to form a contiguous pattern of liquid material. However, the merging or coalescence of the amounts of liquid material may be produced when substrate 54 is contacted by another surface with which substrate 54 is to be adhesively bonded. The pattern of adhesive is applied to the substrate 54 by a single cycle of the valve element 26 that supplies liquid material through liquid supply passage 22 to supply cavity 38.

The nozzle plate 14 may be formed of any material, including tool steels such as A.I.S.I. Type A-2 tool steel, to which a smooth surface finish is readily applied. Tool steels typically have a high purity composition, which has been observed to result in fewer occlusions, such as pits or inclusions, in the downstream surface 44. The reduction in number of inclusions is believed to reduce defects on the downstream surface 44 proximate to the outlets 52 and, as a result, to improve the quality of the dispensed streams of liquid material. Tool steels, in particular, are resistant to scratching from contact with objects in the environment of dispenser 10, as compared with conventional nozzle construction materials such as aluminum, and have a relatively low thermal conductivity. The heat-treatability of tool steels also permits hardening of the nozzle plate 14, after the conclusion of the machining operations forming channels 42, for purposes of increasing wear resistance.

With reference to FIG. 4 and in accordance with an alternative embodiment, the invention contemplates that the dispenser 10 may include a conventional nozzle (not shown) having a single passageway 42 in which the outlet 52 is free of defects, as described above, and the downstream surface 44 has a surface finish proximate to the outlet 52, also as described above. This design may be appropriate for dispensing a single continuous bead of liquid material or discrete amounts of liquid material in a discontinuous line.

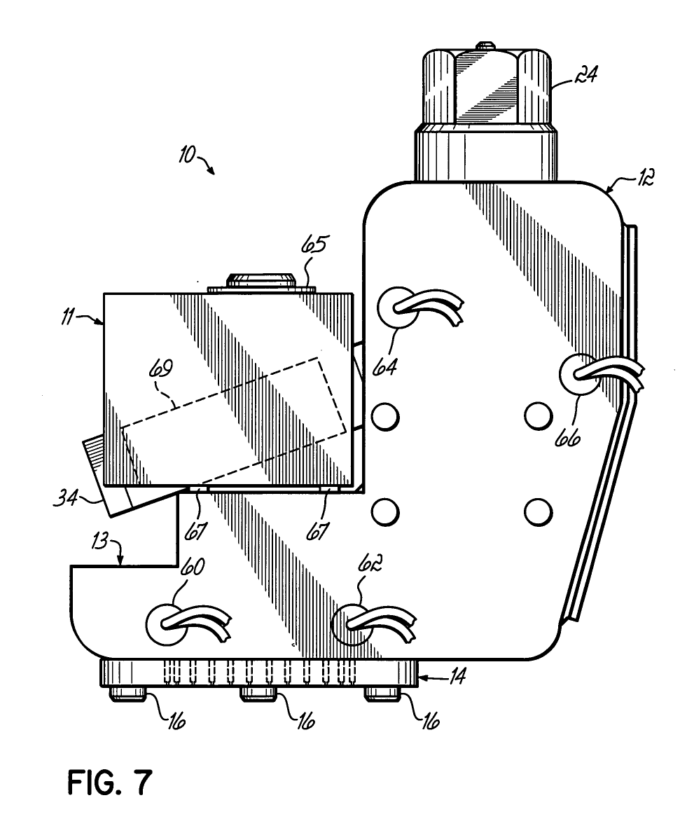

With reference to FIGS. 1 and 7, the dispenser 10 is heated by multiple heater cartridges 60, 62, 64, and 66 to maintain the liquid material flowing in liquid passageway 21 at a suitable temperature and, hence, viscosity. Generally, heat flows outwardly from the heater cartridges 60, 62, 64, and 66. The temperature of various portions of the dispenser 10 differs because of heat loss to the surrounding environment. Heater cartridges 60 and 62 are positioned proximate to the nozzle plate 14 for promoting efficient heat flow to the nozzle plate 14 and, in particular, each of the heater cartridges 60, 62 is aligned with a row of channels 42. In instances that nozzle plate 14 is formed from a tool steel having a relatively-low thermal conductivity as compared, for example, with aluminum and a greater durability than aluminum, the positioning of the heater cartridges 60 and 62 may be determined by thermal modeling. The improved distribution of heat to the nozzle plate 14 improves the uniformity of the cut-off of liquid material at each of the outlets 52.

The air manifold 11 and the solenoid valve 30 of dispenser 10 are isolated thermally from the heated dispensing head 13. A plurality of, for example, three substantially-identical spacers 67 constituted by a low thermal conductor, such as ceramic buttons, are captured in an air gap defined between the air manifold 11 and the heated dispensing head 13. A Belleville C-clip 65 secured to valve 25 captures the air manifold 11 and provides a downward pressure that retains the spacers 67 between the air manifold 11 and the heated dispensing head 13. Positioned between the solenoid valve 30 and the air manifold 11 is a sheet 69 of a material, such as glass-filled polytetrafluoroethylene (PTFE), characterized by a low thermal conductivity. PTFE is the homopolymer of tetrafluoroethylene commercially available as TEFLON® from DuPont. The sheet 69 incorporates air passageways appropriate for transferring air pressure from the air manifold 11 to the valve 25. The redundant thermal isolation afforded by spacers 67 and sheet 69 significantly extends the lifetime of the solenoid valve 30, which operates at a lower temperature, and thereby reduces customer maintenance. As used herein, a low thermal conductivity is substantially less that the thermal conductivity of common stainless steels.

With reference to FIG. 8 in which like reference numerals refer to like features in FIGS. 1-7, a nozzle plate 70 configured to mate with dispenser 10 includes a single line or row of dispense passageways 72, similar to dispense passageways 48 (FIG. 2). Each of the dispense passageways 72 includes an outlet (not shown but similar to outlet 52 of each dispense passageway 48) from which liquid material is dispensed when dispenser 10 is operating. When installed on dispenser 10, the dispense passageways 72 receive liquid material supplied from supply cavity 38. The outlets of the dispense passageways 72 are also arranged in a line. Accordingly, the pattern of liquid material dispensed from nozzle plate 70 will be a line of interconnected or non-interconnected amounts of liquid material, which depends at least in part on the individual volumes and velocities.

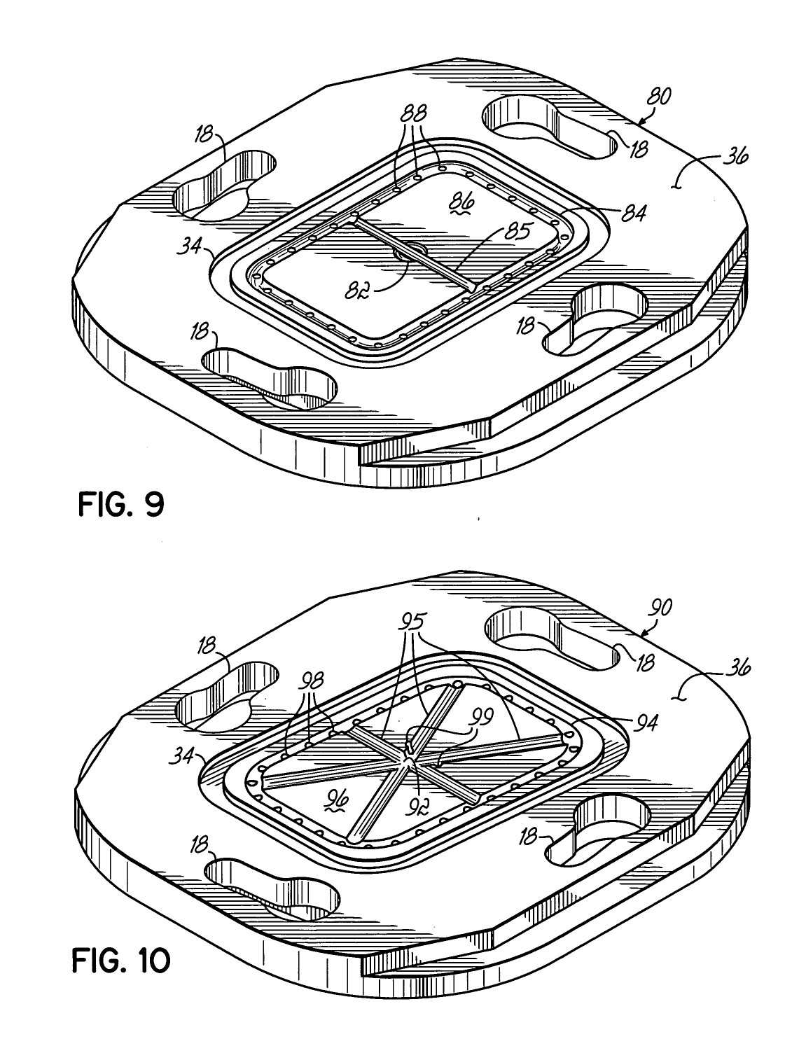

With reference to FIG. 9 in which like reference numerals refer to like features in FIGS. 1-8, a nozzle plate 80 configured to mate with dispenser 10 includes a central recess 82 capable of being registered vertically with liquid supply passage 22 and a ring-shaped liquid distribution passageway 84 coupled with the central recess 82 by a linear liquid distribution passageway 85. The central upstream surface 86 of nozzle plate 80 is no longer recessed below the surrounding peripheral surface 36. Instead, the central recess 82 and the linear liquid distribution passageway 85 are recessed into surface 86 with a semi-circular cross-sectional profile to define a supply cavity between upstream surface 86 and the confronting surface 33 of dispenser 10. A plurality of dispense passageways 88, similar to dispense passageways 48 (FIG. 2), are located in the ring-shaped liquid distribution passageway 84. Each of the dispense passageways 88 includes an outlet (not shown but similar to outlet 52 of each dispense passageway 48) from which liquid material is dispensed when dispenser 10 is operating. The outlets of the dispense passageways 88 are arranged in a ring such that the pattern of liquid material dispensed from nozzle plate 80 will be a ring of interconnected or non-interconnected amounts of liquid material.

With reference to FIG. 10 in which like reference numerals refer to like features in FIGS. 1-9, a nozzle plate 90 configured to mate with dispenser 10 includes a central recess 92 capable of being registered vertically with liquid supply passage 22 and a ring-shaped liquid distribution passageway 94 coupled with the central recess 92 by multiple linear liquid distribution passageways 95 that extend radially outward from the central recess 92. The central upstream surface 96 of nozzle plate 90 is not recessed below the surrounding peripheral surface 36. Instead, the central recess 92 and the linear liquid distribution passageways 95 are recessed into the surface 36, which collectively define a supply cavity between upstream surface 86 and the confronting surface 33 when the nozzle plate 90 is mounted to dispenser 10. To that end, the linear liquid distribution passageways 95 are recesses of semi-circular cross-section in surface 36 that intersect at the shared recess 92.

A plurality of dispense passageways 98, similar to dispense passageways 48 (FIG. 2), are located in the ring-shaped liquid distribution passageway 94. Additional dispense passageways 99 are provided near the central recess 92 or, optionally, in one of the linear liquid distribution passageways 95. Each of the dispense passageways 98 and 99 includes an outlet (not shown but similar to outlet 52 of each dispense passageway 48) from which liquid material is dispensed when dispenser 10 is operating. The outlets of the dispense passageways 98 are arranged in a ring that encircles the outlets of dispense passageways 99. Accordingly, the pattern of liquid material dispensed from nozzle plate 90 will be a ring of interconnected or non-interconnected amounts of liquid material that encircles two amounts of liquid material, which may merge together.

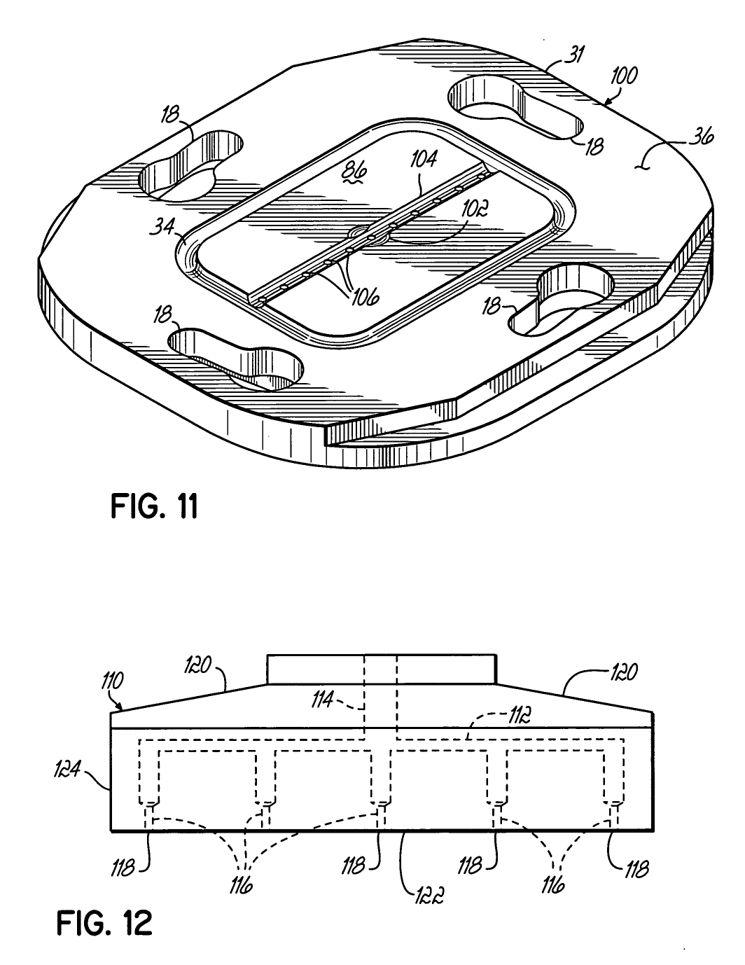

With reference to FIG. 11 in which like reference numerals refer to like features in FIGS. 1-10, a nozzle plate 100 configured to mate with dispenser 10 includes a central recess 102 capable of being registered vertically with liquid supply passage 22 and a linear passageway 104 of semi-circular cross-sectional profile coupled with the central recess 102. The central recess 102 and the linear passageway 104 collectively define a supply cavity between upstream surface 86 and the confronting surface 33. A plurality of dispense passageways 106, similar to dispense passageways 48 (FIG. 2), are located in the passageway 104. Each of the dispense passageways 106 includes an outlet (not shown but similar to outlet 52 of each dispense passageway 48) from which liquid material is dispensed when dispenser 10 is operating. The outlets of the dispense passageways 106 are arranged in a line or row such that the pattern of liquid material dispensed from nozzle plate 100 will be a line of interconnected or non-interconnected amounts of liquid material.

With reference to FIG. 12 and in which like reference numerals refer to like features in FIGS.1 -11, a T-bar nozzle plate 110 configured to mate with dispenser 10 includes a supply cavity 112, similar to supply cavity 38 (FIG. 3), that is coupled with liquid supply passage 22 (FIG. 3) by a liquid passageway 114. Passageway 114 provides liquid to plurality of dispense passageways 116, each similar to dispense passageways 48 (FIG. 2). Liquid material is dispensed from an outlet 118 of each of the dispense passageways 116 when dispenser 10 (FIG. 1) is operating. The outlets 118 may be arranged in a line or row such that the pattern of liquid material dispensed from T-bar nozzle plate 110 will be a line of interconnected or non-interconnected amounts of liquid material.

Generally, the T-bar nozzle includes a top wall 120 having a width dimension (into and out of the plane of the page of FIG. 12) that is greater than the width dimension of a bottom wall 122. The side wall 124 connecting the top and bottom walls 120, 122 tapers in a downward direction toward the bottom wall 122. Accordingly, the walls 120,122,124 of the T-bar nozzle body 110 are configured such that progressively less heat is required to be transferred therethrough in the course of passage of heated liquid material from the liquid passageway 114 to the outlets 118 of the dispense passageways 116. The wall configuration of T-bar nozzle body 110 is further described in commonly-assigned U.S. Pat. Nos. 4,659,016 and 5,027,976, which are hereby incorporated by reference herein in its entirety. Such T-bar nozzle bodies have been employed, for example, in cartoning and packaging applications to apply a number of laterally spaced beads to the flaps of a carton.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicants' general inventive concept. The scope of the invention itself should only be defined by the appended claims.

1. A nozzle for a dispenser of a liquid material, comprising:
a body adapted to be coupled with the dispenser, said body including a downstream surface, a plurality of liquid passageways each including a sidewall and an outlet defined on said downstream surface at an intersection between said sidewall and said downstream surface, and a supply cavity coupling said plurality of liquid passageways coupled in fluid communication with the dispenser, wherein said downstream surface includes a surface finish proximate to said outlet of each of said plurality of liquid passageways having a surface roughness of less than or equal to about 16 microinches, and said intersection between said sidewall of each of said plurality of liquid passageways and said downstream surface is geometrically sharp.

2. The nozzle of claim 1 wherein said outlet of each of said plurality of liquid passageways is substantially free of defects.

3. The nozzle of claim 1 wherein said sidewall of each of said plurality of liquid passageways and said downstream surface are coextensive.

4. The nozzle of claim 1 wherein said sidewall intersects said downstream surface at approximately 90° relative to said downstream surface at any point on a circumference of said outlet.

5. The nozzle of claim 1 wherein the surface finish is applied across said downstream surface.

6. The nozzle of claim 1 wherein said sidewall intersects said downstream surface at any point on a circumference of said outlet with an intersection angle, and a sum of said intersection angle at a first point on said circumference and said intersection angle at a second diametrically-opposed point on said circumference equaling 180°.

7. The nozzle of claim 1 wherein said nozzle plate is a T-bar nozzle plate.

8. The nozzle of claim 7 wherein said nozzle plate includes a top wall, a bottom wall, and a tapered sidewall connecting said top and bottom walls, said supply cavity being positioned between said top wall and said bottom wall, and said sidewall tapering in a direction from said top wall to said bottom wall.

9. The nozzle of claim 1 wherein said body includes an upstream surface and a recessed region formed in said upstream surface, and said supply cavity is defined by said recessed region as an enclosed space between said upstream surface and the dispenser.

10. The nozzle of claim 9 wherein recessed region includes an interconnected plurality of liquid distribution passageways recessed into said upstream surface.

11. A dispenser comprising said nozzle of claim 1, a supply passage coupled in fluid communication with said supply cavity, and a valve operative for directing substantially uniform output volumes of the liquid material into said supply passage.

12. The dispenser of claim 11 wherein said supply cavity has a volume substantially equal to each of said output volumes of the liquid material supplied by said valve.

13. A nozzle for a dispenser, comprising:
a body adapted to be coupled with the dispenser, said body including a downstream surface, an upstream surface, and one or more liquid passageways each extending from said upstream surface to said downstream surface, each of said one or more liquid passageways including a sidewall and an outlet defined on said downstream surface at an intersection between said sidewall and said downstream surface, wherein said downstream surface includes a surface finish proximate to said outlet of each of said one or more liquid passageways having a surface roughness of less than or equal to about 16 microinches, and said intersection between said sidewall of each of said one or more liquid passageways and said downstream surface is geometrically sharp.

14. The nozzle of claim 13 wherein said outlet of each of said plurality of liquid passageways is substantially free of defects.

15. The nozzle of claim 13 wherein said sidewall of each of said plurality of liquid passageways and said downstream surface are coextensive.

16. The nozzle of claim 13 wherein said sidewall intersects said downstream surface at approximately 90° relative to said downstream surface at any point on a circumference of said outlet.

17. The nozzle of claim 13 wherein said sidewall intersects said downstream surface at any point on a circumference of said outlet with an intersection angle, and a sum of said intersection angle at a first point on said circumference and said intersection angle at a second diametrically-opposed point on said circumference equaling 180°.

18. A dispenser comprising said nozzle of claim 13, a supply passage coupled with each of said one or more liquid passageways, and a valve operative for directing the liquid material into said supply passage.

19. A method for dispensing a liquid material onto a substrate, comprising:
supplying a volume of the liquid material from a dispenser to a supply cavity having a volume substantially equal to the volume of the liquid material;
distributing the volume of the liquid material substantially equally among a plurality of liquid passageways in a nozzle; and
dispensing the volume of the liquid material from the plurality of liquid passageways with a pattern onto the substrate.

20. The method of claim 19 wherein dispensing the volume of the liquid material further comprises:
dispensing the volume of the liquid material as a plurality of discrete amounts onto the substrate.

21. The method of claim 19 wherein at least two of the plurality of discrete amounts of the liquid material merge together on the substrate.

22. The method of claim 19 wherein the plurality of passageways have a first arrangement, and further comprising:
coupling the dispenser with a different nozzle having a second arrangement for the plurality of passageways that differs from the first arrangement in order to change the pattern of the liquid material dispensed onto the substrate.

23. The method of claim 22 wherein the different nozzle is coupled with the dispenser without modifying the dispenser.
